(19) United States
(12) Patent Application Publication
(10) Pub. No.: US 2019/0012729 A1
(43) Pub. Date: Jan. 10, 2019

(54) IMAGE COMPOSING DEVICE

(71) Applicant: FUJI XEROX CO., LTD., Tokyo (JP)

(72) Inventor: Yasunari KISHIMOTO, Kanagawa (JP)

(73) Assignee: FUJI XEROX CO., LTD., Tokyo (JP)

(21) Appl. No.: 15/909,310

(22) Filed: Mar. 1, 2018

(30) Foreign Application Priority Data
Jul. 5, 2017 (JP) 2017-131914

(51) Int. Cl. G06Q 30/06; G06T 1/00; G06T 15/20

(52) U.S. Cl. CPC G06Q 30/0643; G06T 2211/00; G06T 15/205; G06T 1/0007

(57) ABSTRACT

An image composing device includes first, second, and third obtaining units, a generator, and a composing unit. The first obtaining unit obtains label data indicating an image of a label to be attached to a product item. The second obtaining unit obtains configuration data indicating a three-dimensional configuration of the product item. The third obtaining unit obtains background data indicating an image to be used as a background. The generator generates projection information for projecting the three-dimensional configuration on the background. The composing unit combines the image of the label with the image of the background by using the projection information.

### CROSS-REFERENCE TO RELATED APPLICATIONS

This application is based on and claims priority under 35 USC 119 from Japanese Patent Application No. 2017-131914 filed Jul. 5, 2017.

### BACKGROUND

### Technical Field

The present invention relates to an image composing device.

### SUMMARY

According to an aspect of the invention, there is provided an image composing device including first, second, and third obtaining units, a generator, and a composing unit. The first obtaining unit obtains label data indicating an image of a label to be attached to a product item. The second obtaining unit obtains configuration data indicating three-dimensional configuration of the product item. The third obtaining unit obtains background data indicating an image to be used as a background. The generator generates projection information for projecting the three-dimensional configuration on the background. The composing unit combines the image of the label with the image of the background by using the projection information.

### BRIEF DESCRIPTION OF THE DRAWINGS

An exemplary embodiment of the present invention will be described in detail based on the following figures, wherein:

FIG. 1 illustrates the configuration of an image composing device according to the exemplary embodiment;

FIGS. 2A, 2B, and 2C respectively illustrate a label database (DB), a configuration DB, and a background DB stored in a storage unit;

FIG. 3 illustrates an example of a label;

FIGS. 4A and 4B illustrate an example of a three-dimensional configuration;

FIGS. 5A, 5B, and 5C illustrate three examples of backgrounds;

FIG. 6 illustrates the functional configuration of the image composing device;

FIG. 7 is a flowchart illustrating an operation of the image composing device; and

FIGS. 8A, 8B, and 8C illustrate pieces of image content generated by combining an image of a label with images of backgrounds.

### DETAILED DESCRIPTION

### 1. Exemplary Embodiment

### 1-1.Overall Configuration of Image Composing Device

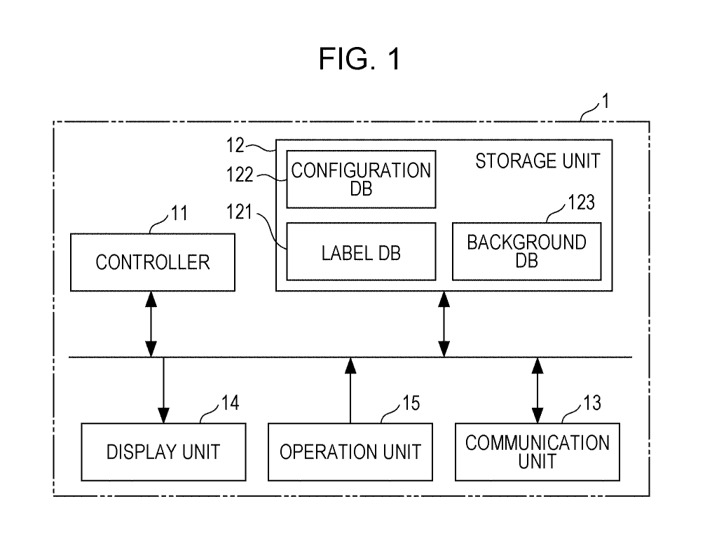

FIG. 1 illustrates the configuration of an image composing device 1 according to an exemplary embodiment. The image composing device 1 includes a controller 11, a storage unit 12, a communication unit 13, a display unit 14, and an operation unit 15.

To promote the sales of a certain product item, printed materials, such as posters, stickers, and pamphlets, are created by using photos of this item and images of illustrations simulating this item. In addition to printed materials, displayed materials, such as online advertisements and television advertisements, may be produced by using images representing this item. These printed materials and display materials are called promotional materials. The image composing device 1 is a device for producing content used for promotional materials by combining images. Hereinafter, such content will be called image content.

The controller 11 includes a central processing unit (CPU), a read only memory (ROM), and a random access memory (RAM). As a result of reading and executing computer programs (hereinafter simply called programs) stored in the ROM and the storage unit 12, the CPU controls the individual elements of the image composing device 1.

The communication unit 13 is a communication circuit which connects to a communication line, such as the Internet, via a wireless medium or a wired medium. By using the communication unit 13, the image composing device 1 sends and receives information to and from various devices connected to the communication line. The provision of the communication unit 13 in the image composing device 1 may be omitted.

The operation unit 15 includes operators, such as operation buttons, for providing various instructions. The operation unit 15 receives an instruction from a user and supplies a signal to the controller 11 in accordance with the content of the instruction. The operation unit 15 may include a touchscreen which detects the presence of an operator, such as a user's finger or a stylus. If the controller 11 receives various user instructions from external terminals via the communication unit 13, the provision of the operation unit 15 in the image composing device 1 may be omitted.

The display unit 14 includes a display screen, such as a liquid crystal display, and displays images under the control of the controller 11. A transparent touchscreen of the operation unit 15 may be superposed on the display screen of the display unit 14.

The storage unit 12 is a large-capacity storage, such as a solid state drive or a hard disk drive, and stores various programs read by the CPU of the controller 11.

The storage unit 12 stores a label database (DB) 121, a configuration DB 122, and a background DB 123. The label DB 121 is a database that stores label data indicating images of labels to be attached to product items. “Attaching a label to a product item” refers to that a sheet of paper, for example, on which an image of a label is formed, is bonded to a product item by using an adhesive and also that, if a product item is a sheet-like item, an image of a label is formed directly on the surface of the item. A label may not necessarily be directly attached to a product item. Instead, a label may be tied to a product item with a string or a ribbon or be attached to an accessory of a product item. A label may be projected on a product item as an image as in projection mapping. One piece of label data stored in the label DB 121 is not restricted to an image of a label indicated in one continuous region, but may be an image of a set of labels separately indicated in plural regions.

The configuration DB 122 is a database that stores configuration data indicating the three-dimensional configurations of product items. The background DB 123 is a database that stores background data indicating images to be used as backgrounds.

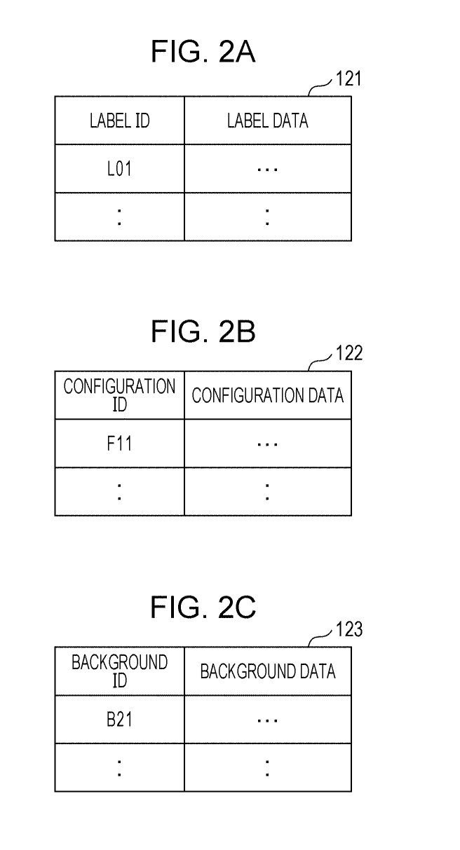

FIGS. 2A, 2B, and 2C respectively illustrate examples of the label DB 121, the configuration DB 122, and the background DB 123 stored in the storage unit 12. The label DB 121 shown in FIG. 2A stores label IDs, which serve as identification information for identifying labels, and the above-described label data in association with each other. The configuration DB 122 shown in FIG. 2B stores configuration IDs, which serve as identification information for identifying three-dimensional configurations of product items, and the above-described configuration data in association with each other. The background DB 123 shown in FIG. 2C stores background IDs, which serve as identification information for identifying backgrounds, and the above-described background data in association with each other.

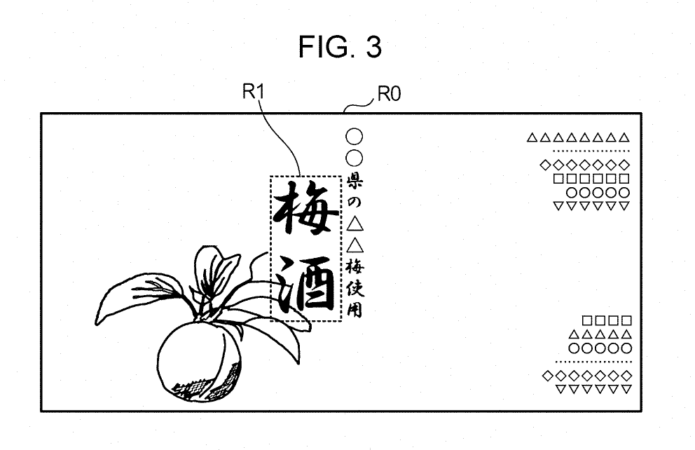

FIG. 3 illustrates an example of a label. When a user specifies a label ID by using the operation unit 15, label data corresponding to the specified label ID is read from the label DB 121. As shown in FIG. 3, the image of a label indicated by label data is constituted by an illustration related to a product item and a character string representing the name of the item, for example. The image of a label may also include a description of an item or a barcode representing ID information and a price of the item. In the entire region R0 of the label, a region R1 is a region to which a viewer (customer) focusses attention (hereinafter called a focusing region). The region R1 may be selected by a user using the operation unit 15 or may be specified by metadata included in label data.

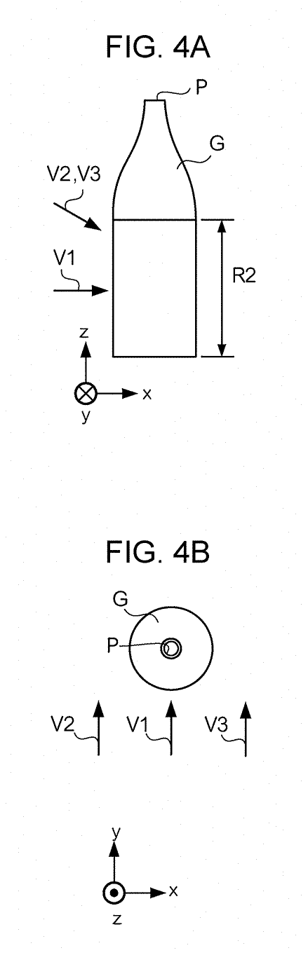

FIGS. 4A and 4B illustrate an example of the three-dimensional configuration. The three-dimensional configuration of a product item means the configuration of a product item in a three-dimensional space. In FIGS. 4A and 4B, the three-dimensional space is represented by the right-handed xyz coordinate system. Among the coordinate symbols shown in FIGS. 4A and 4B, a symbol of a circle containing a dot in FIG. 4B represents an arrow heading from the far side to the near side in the drawing, while a symbol of a circle containing two crossing lines in FIG. 4A represents an arrow heading from the near side to the far side in the drawing. In the three-dimensional space, the direction along the x axis is called an x-axis direction. The x-axis direction in which an x component increases is called a +x direction, while the x-axis direction in which an x component decreases is called a −x direction. A y-axis direction, a +y direction, a −y direction, a z-axis direction, a +z direction, and a −z direction are also defined in a similar manner.

In the example in FIGS. 4A and 4B, +z direction is the upward direction, while the −z direction is the downward direction. The −y direction is the forward direction, while the +y direction is the backward direction. The +x direction is the rightward direction, while the −x direction is the leftward direction.

The product item G shown in FIGS. 4A and 4B is a bottle-shaped item with an opening P facing the +z direction and a bottom portion facing the −z direction. FIG. 4A shows the product item G as viewed in the +y direction, that in the backward direction. FIG. 4B shows the product item G as viewed in the −z direction, that is, in the downward direction.

The configuration data indicates the three-dimensional configuration of the product item G. Any data structure that can repro the three-dimensional configuration of the external surface of the product item G may be used for the configuration data. For example, the constructive solid geometry (CSG) technique or the boundary representation (B-rep) technique may be used.

The configuration data also indicates a region R2 where a label will be attached, on the surface of the product item G. The region R2 shown in FIG. 4A is a region corresponding to the lateral surface of the cylindrical portion of the bottle-shaped product item G where the sectional area changes less sharply than that of the other portions. Concerning the portion higher than the region R2 in the +z direction, the sectional area becomes smaller progressively in the +z direction. The opening P is provided at the end portion of the product item G in the +z direction. By tilting the product item G, for example, a liquid flows out from the inside of the product item G through the opening P.

The three-dimensional configuration of the product item is not restricted to a bottle shape. Examples of the other three-dimensional configurations are rectangular-parallelepiped configurations representing a refrigerator, a makeup box, etc., bar-like configurations representing a fountain pen, a ballpoint pen, etc., and flat-shaped configurations representing a smartphone, a tablet terminal, etc.

The product item G is not restricted to an item which occupies a single continuous space, but may be a set of plural items that are combined so that the relative positions of the plural items can be changed, such as a watch, a bicycle, and a tea set. In this case, the three-dimensional configuration of a set of items G is the configurations of the individual items or the configuration of the combined items. The product item G may be an item including a sheet-like portion, such as a string, a ribbon, a strap.

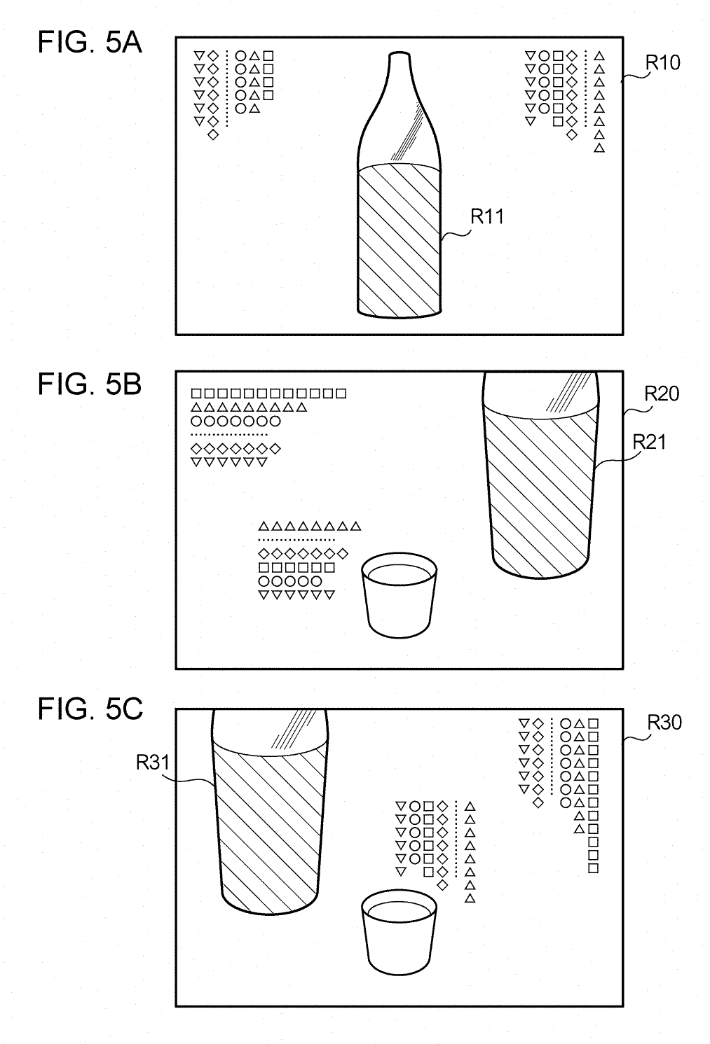

FIGS. 5A, 5B, and 5C illustrate three examples of backgrounds. As the background shown in FIG. 5A, a photo of the product item G taken from the direction V1 indicated in FIGS. 4A and 4B is used. The direction V1 is a direction being parallel with the direction and facing the product item G straight. In the background in FIG. 5A, the configuration of the product item G as viewed from the front side is represented. The region R2 shown in FIG. 4A where a label will be attached is associated with a region R11 (hereinafter will be called the associated region R11) indicated by the hatched portion in FIG. 5A within a region R10 representing the entire background.

As the background shown in FIG. 5B, a photo of the product item G taken from the direction V2 indicated in FIGS. 4A and 4B is used. The direction V2 is a direction in which a +y direction component and a −z direction component are combined and a direction facing a portion farther toward the −x direction (left side) than the product item G. In the background in FIG. 5B, the configuration of the product item G as obliquely viewed from the top left side is represented. The region R2 shown in FIG. 4A where a label will be attached is associated with a region R21 (hereinafter will be called the associated region R21) indicated by the hatched portion in FIG. 5B within a region R20 representing the entire background.

As the background shown in FIG. 5C, a photo of the product item G taken from the direction V3 indicated in FIGS. 4A and 4B is used. The direction V3 is a direction in which a +y direction component and a −z direction component are combined and a direction facing a portion farther toward the +x direction (right side) than the product item G. In the background in FIG. 5C, the configuration of the product item G as obliquely viewed from the top right side is represented. The region R2 shown in FIG. 4A where a label will be attached is associated with a region R31 (hereinafter will be called the associated region R31) indicated by the hatched portion in FIG. 5C within a region R30 representing the entire background.

### 1-2. Functional Configuration of Image Composing Device

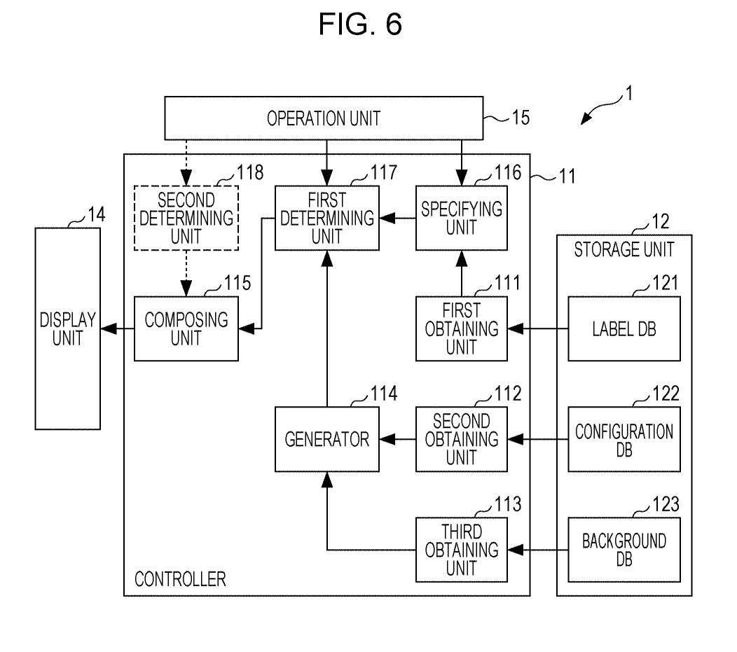

FIG. 6 illustrates the functional configuration of the image composing device 1. As a result of executing a program stored in the storage unit 12 shown in FIG. 1, the controller 11 functions as a first obtaining unit 111, a second obtaining unit 112, a third obtaining unit 113, a generator 114, a composing unit 115, a specifying unit 116, and a first determining unit 117.

The first obtaining unit 111 obtains label data indicating the image of a label to be attached to the product item G. The first obtaining unit 111 shown in FIG. 6 obtains label data from label DE 121 stored in the storage unit 12. The first obtaining unit 111 may obtain label data of a label ID specified by a user using the operation unit 15. The image indicated by the obtained label data is attached to the region R2 of the product item G shown in FIG. 4A.

The second obtaining unit 112 obtains configuration data indicating the three-dimensional configuration of the product item G. The second obtaining unit 112 shown in FIG. 6 obtains configuration data from the configuration DB 122 stored in the storage unit 12. The second obtaining unit 112 may obtain configuration data of a configuration ID specified by a user using the operation unit 15.

The third obtaining unit 113 obtains background data indicating an image to be used as a background. The third obtaining unit 113 shown in FIG. 6 obtains background data from the background DB 123 stored in the storage unit 12. The third obtaining unit 113 may obtain background data of a background ID specified by a user using the operation unit 15.

The generator 114 generates projection information for projecting a three-dimensional configuration on a background. For example, if the second obtaining unit 112 obtains configuration data indicating the three-dimensional configuration shown in FIGS. 4A and 4B and if the third obtaining unit 113 obtains background data indicating the background shown in FIG. 5A, the generator 114 shown in FIG. 6 extracts the associated region R11 from the background data.

Various approaches to extracting the associated region R11 from the background data are possible. For example, if the color of the product item G is described in the configuration data, the generator 114 may extract, as the associated region R11, a region represented by the same color as that of the product item G from the background indicated by the background data.

The associated region R11 may be described in the background data in advance. In this case, the generator 114 extracts the associated region R11 from the background data.

After extracting the associated region R11, the generator 114 changes the orientation of the product item G indicated by the configuration data with respect to a plane so that the configuration of the product item G projected on a plane will match the configuration of the boundary of the associated region R11. In this manner, the generator 114 generates projection information for projecting the product item G on the background. The projection information indicates the orientation and the viewpoint, for example, of the product item G with respect to a plane corresponding to the background.

As models used for projecting the configuration of the product item G on the background, perspective projection models are used. Alternatively, weak perspective projection models, pseudo-perspective projection models, or parallel perspective projection models may be used, instead. The generator 114 sets a condition for each projection model, and when the configuration data or the associated region satisfies the condition applied to a certain projection model, the generator 114 may use this projection model.

The generator 114 may use the orientation and the viewpoint of the project item G with respect to the background, which are specified by a user using the operation unit 15. In this case, the generator 114 generates projection information in accordance with the orientation and the viewpoint specified by the user. The user may not have to specify the precise values of the orientation and viewpoint, and the generator 114 may estimate the orientation and viewpoint of the product item G by using the numeric values input by the user as initial values.

The specifying unit 116 specifies a certain region within a label as the above-described focusing region. The specifying unit 116 shown in FIG. 6 may use a region selected by a user using the operation unit 15 as the focusing region. The focusing region may alternatively be indicated in label data.

The first determining unit 117 determines a position of a portion of the product item G to which a label is attached, based on the focusing region and the projection information. For example, the region R2 of the product item G shown in FIG. 4A is a lateral surface of the cylindrical portion about the z axis. Although the z-axis position of the region R2 to which a label is attached is fixed, the circumferential position of the region R2 to which the label is attached is not fixed. By using the viewpoint and the line-of-sight direction described in the projection information, the first determining unit 117 shown in FIG. 6 determines the position of the focusing region within the region to which a label is attached in accordance with a predetermined rule. The predetermined rule may be the one that the position of the focusing region within the product item G is determined so that the focusing region will match the viewpoint in a three-dimensional space.

The composing unit 115 combines the image of a label with the image of a background by using the projection information generated by the generator 114. More specifically, the composing unit 115 shown in FIG. 6 modifies the image of the label attached to the product item G to the configuration to be viewed from the viewpoint indicated by the projection information when the product item G is projected on the background, and then combines the modified image of the label with the image of the background. In this case, the composing unit 115 combines the image of the label attached to the position of the portion of the product item G determined by the first determining unit 117 with the image of the background. In this case, combining of the image of the label with the image of the background is composing of an image that will be viewed. Thus, composing of such an image may be implemented by projection, virtual reality, mixed reality, or augmented reality.

### 1-3. Operation of Image Composing Device

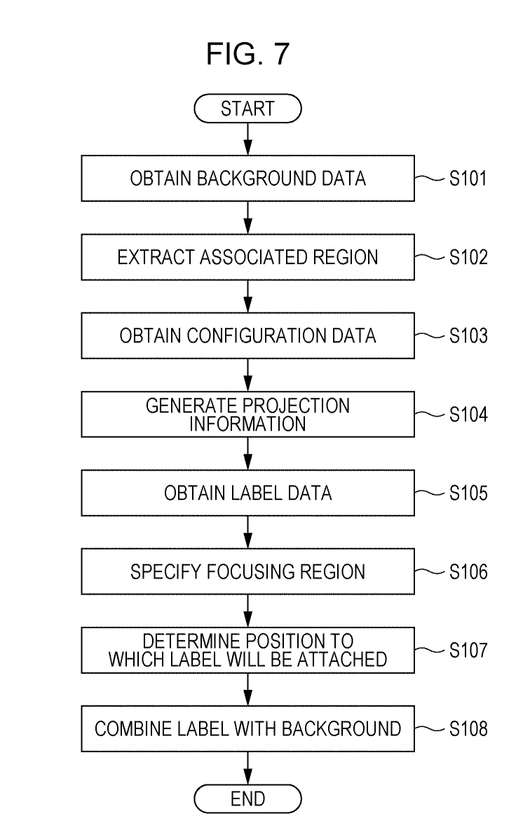

FIG. 7 is a flowchart illustrating the operation of the image composing device 1. In step S101, the controller 11 of the image composing device 1 obtains background data from the background DB 123. In step S102, the controller 11 then extracts an associated region to which a label will be attached from the background indicated by the background data.

In step 103, the controller 11 obtains configuration data from the configuration DB 122. In step S104, by referring to the associated region extracted in step S102, the controller 11 generates projection information for projecting the three-dimensional configuration indicated by the configuration data on the background.

In step S105, the controller 11 obtains label data from the label DB 121. Then, in step S106, the controller 11 specifies a focusing region within the label indicated by the label data. In step S107, based on the projection information, the controller 11 specifies a position of a portion of the product item G to which the label will be attached in accordance with a predetermined rule.

In step S108, the controller 11 modifies the image of the label attached to the specified position of the product item G to the configuration to be viewed when the three-dimensional configuration of the product item G is projected on the background, and then combines the modified image of the label with the background.

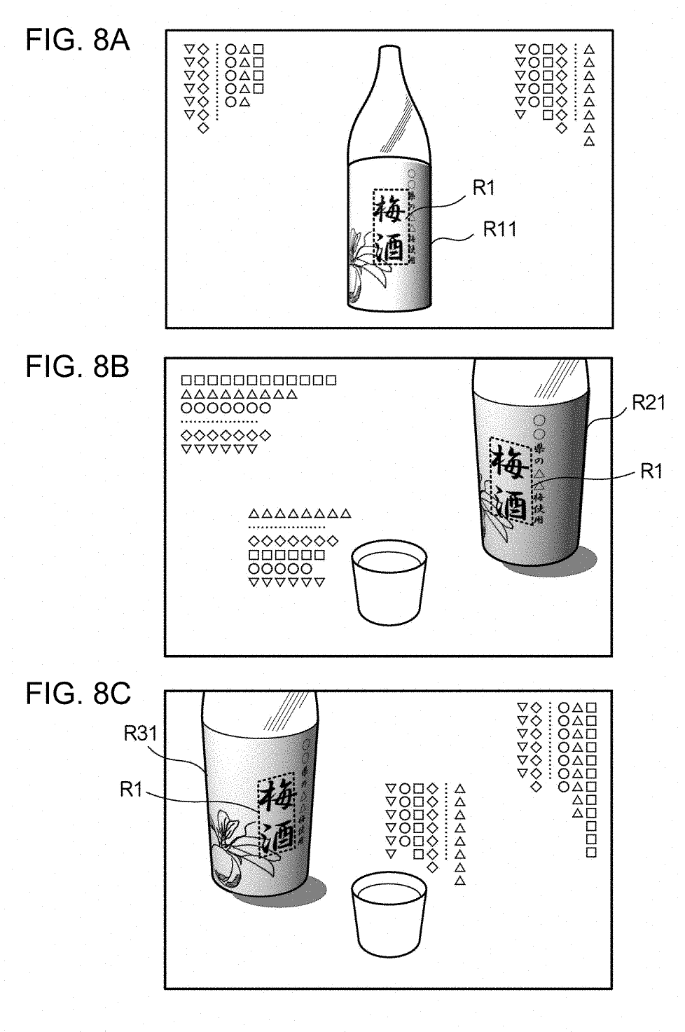

As a result of executing the above-described operation, images of a product item G projected on backgrounds in different compositions are composed by using a label to be attached to the product item G. FIGS. 8A, 8B, and 8C respectively illustrate pieces of image content generated by combining the label image shown in FIG. 3 with the background images shown in FIGS. 5A, 5B, and 5C.

The image content shown in FIG. 8A is an image composed by combining the image of the label shown in FIG. 3 with the associated region R11 of the background shown in FIG. 5A. In this image content, a photo of the product item G as viewed from the front side is used as the background, and the region R1, which is a focusing region, is thus located at the center of the associated region R11 so as to match the viewpoint. The image of the label is first modified into a configuration of a label wrapped around the cylindrical portion of the product item G, and is then combined with the image of the background.

The image content shown in FIG. 8B is an image composed by combining the image of the label shown in FIG. 3 with the associated region R21 of the background shown in FIG. 5B. In this image content, a photo of the product item G as obliquely viewed from the top left side is used as the background, and the region R1, which is a focusing region, is thus located at a position toward the left side within the associated region R21 so as to match the viewpoint. The image of the label is first modified into a configuration of a label wrapped around the cylindrical portion of the product item G, and is then combined with the image of the background.

The image content shown in FIG. 8C is an image composed by combining the image of the label shown in FIG. 3 with the associated region R31 of the background shown in FIG. 5C. In this image content, a photo of the product item G as obliquely viewed from the top right side is used as the background, and the region R1, which is a focusing region, is thus located at a position toward the right side within the associated region R31 so as to match the viewpoint. The image of the label is first modified into a configuration of a label wrapped around the cylindrical portion of the product item G, and is then combined with the image of the background.

Hitherto, in the production of image content representing a commercial product item for a variety of media, if the taste, style, and composition of the image content are changed according to the type of media, different photos of the product item have to be prepared in accordance with the type of media.

In contrast, in the above-described image composing device 1, by using label data indicating one label or one set of labels and configuration data indicating the three-dimensional configuration of one product item or one set of product items, the label or the set of labels is combined with backgrounds representing the product item or the set of product items in different compositions, tastes, and styles. The production process is thus simplified without the need to prepare various photos of a product item taken in different compositions, tastes, and styles according to the type of media.

### 2. Modified Examples

The above-described exemplary embodiment is only an example and may be modified in the following manner. Additionally, the following modified examples may be combined according to the necessity.

### 2-1. First Modified Example

In the above-described exemplary embodiment, the image composing device 1 includes the display unit 14. However, the provision of the display unit 14 may be omitted. The controller 11 may store composed images in the storage unit 12 or may send composed images to an external device by using the communication unit 13.

The image composing device 1 may include an image forming unit which forms an image composed by the controller 11 on a medium, such as a sheet. In this case, the image forming unit may be an electrophotographic image forming unit.

### 2-2. Second Modified Example

In the above-described exemplary embodiment, the specifying unit 116 specifies a certain region within a label as the above-described focusing region, and the first determining unit 117 determines a position of a portion of the product item G to which the label will be attached, based on the focusing region and the projection information. However, the position of a portion of the product item G to which a label will be attached may be determined in advance. In this case, the controller 11 may not necessarily function as the specifying unit 116 and the first determining unit 117.

### 2-3. Third Modified Example

In the above-described exemplary embodiment, the composing unit 115 combines the image of a label with the image of a background by using the projection information generated by the generator 114. The composing unit 115 may also provide shading to the image of a label in accordance with the orientation of the product item G in the background. Shading is shades and shadows created for the product item G when it is illuminated. Shading may be provided to the image of a label by adjusting the brightness tone. The provision of shading to a label on the surface of the product item G gives a stronger depth perception to a viewer (customer) of the image content.

### 2-4. Fourth Modified Example

In the above-described third modified example, various approaches to providing shading to the image of a label are possible. For example, the composing unit 115 may provide shading to the image of a label by using a tone level of a portion of the image of a background on which the image of a label will be projected. That is, the composing unit 115 may combine the image of a label with the image of a background by adding the tone value of the associated region of the image of the background and the tone value of the image of the label which has been modified to be projected on the background.

### 2-5. Fifth Modified Example

The composing unit 115 may determine the position of a light source which applies light to the product item G in a three-dimensional space, and then calculate the level of shading to be provided to the image of a label by using the determined position of the light source. In this case, as shown in FIG. 6, as a result of executing the above-described program, the controller 11 functions as a second determining unit 118 that determines the position of a light source which applies light to the product item G defined by a three-dimensional configuration projected on a background. The composing unit 115 provides shading to the image of a label, based on the position of the light source determined by the second determining unit 118.

According to a predetermined rule, the second determining unit 118 may determine the position of the light source, based on the position of the focusing region within a label, the position of the associated region within image content, and the shape of the shading of a product item G provided on the image of a background. The second determining unit 118 may use the position of a light source specified by a user using the operation unit 15.

### 2-6. Sixth Modified Example

The program executed by the controller 11 of the image composing device 1 may be provided as a result of being recorded in a computer readable recording medium, such as a magnetic recording medium (magnetic tape and a magnetic disk, for example), an optical recording medium (an optical disc, for example), or a magneto-optical recording medium, or a semiconductor memory. This program may be downloaded via a communication line, such as the Internet. Instead of using a CPU, various other devices may be used for the controller 11. For example, a dedicated processor may be used.

### 2-7. Seventh Modified Example

In the above-described exemplary embodiment, a photo of the product item G is used as a background. Instead of photos, various other mediums, such as illustrations, pictures, and ink wash paintings simulating the product item G, may be used. In this case, too, the generator 114 extracts an associated region to which a label will be attached from background data.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image composing device comprising:
first obtaining unit that obtains label data indicating an image of a label to be attached to a product item;
a second obtaining unit that obtains configuration data indicating a three-dimensional configuration of the product item;
a third obtaining unit that obtains background data indicating an image to be used as a background;
a generator that generates projection information for projecting the three-dimensional configuration on the background; and
a composing unit that combines the image of the label with the image of the background by using the projection information.

2. The image composing device according to claim 1, further comprising:
a specifying unit that specifies a region to be focused within the label; and
a first determining unit that determines a position of a portion of the product item to which the label will be attached, based on the region to be focused and the projection information,
wherein the composing unit combines the image of the label attached to the determined position with the image of the background.

3. The image composing device according to claim 1, wherein the composing unit provides shading to the image of the label in accordance with an orientation of the product item defined by the three-dimensional configuration projected on the background.

4. The image composing device according to claim 2, wherein the composing unit provides shading to the image of the label in accordance with an orientation of the product item defined by the three-dimensional configuration projected on the background.

5. The image composing device according to claim 3, wherein the composing unit provides the shading to the image of the label by using a tone level of a portion of the image of the background on which the image of the label will be projected.

6. The image composing device according to claim 4, wherein the composing unit provides the shading to the image of the label by using a tone level of a portion of the image of the background on which the image of the label will be projected.

7. The image composing device according to claim 3, further comprising:
a second determining unit that determines a position of a light source which applies light to the product item defined by the three-dimensional configuration projected on the background,
wherein the composing unit provides the shading to the image of the label, based on the determined position of the light source.

8. The image composing device according to claim 4, further comprising:
a second determining unit that determines a position of a light source which applies light to the product item defined by the three-dimensional configuration projected on the background,
wherein the composing unit provides the shading to the image of the label, based on the determined position of the light source.

9. An image composing device comprising:
first obtaining means for obtaining label data indicating an image of a label to be attached to a product item;
second obtaining means for obtaining configuration data indicating a three-dimensional configuration of the product item;
third obtaining means for obtaining background data indicating an image to be used as a background;
generating means for generating projection information for projecting the three-dimensional configuration on the background; and
composing means for combining the image of the label with the image of the background by using the projection information.
